(19) United States
(12) Patent Application Publication
(10) Pub. No.: US 2025/0259316 A1
(43) Pub. Date: Aug. 14, 2025

(54) MOTION ESTIMATION BASED ON MULTIPLE PAIRS OF IMAGES

(71) Applicant: Shanghai United Imaging Intelligence Co., Ltd., Shanghai (CN)

(72) Inventors: Xiao Chen, Lexington, MA (US); Zhang Chen, Brookline, MA (US); Yikang Liu, Cambridge, MA (US); Shanhui Sun, Lexington, MA (US); Terrence Chen, Lexington, MA (US)

(73) Assignee: Shanghai United Imaging Intelligence Co., Ltd., Shanghai (CN)

(21) Appl. No.: 18/438,426

(22) Filed: Feb. 10, 2024

(51) Int. Cl. G06T 7/285

(52) U.S. Cl. CPC G06T 7/285; G06T 2207/10016; G06T 2207/30048

(57) ABSTRACT

A video of medical scan images associated with an anatomical structure may be arranged into multiple image pairs. The multiple image pairs may be provided to a machine learning (ML) model successively and the ML model may determine respective first sets of image features associated with the multiple image pairs and, for each of the multiple image pairs, refine the first set of image features associated with the image pair based on the respective first sets of image features associated with one or more other image pairs. A motion field associated with the image pair may be determined based at least on the refined first set of image features associated with the image pair and a task may be performed based on the respective motion fields.

### BACKGROUND

Motion estimation plays an important role in many medical applications. For example, cardiac motion estimation can be used to calculate subject-specific muscular strain of the myocardium, which could be beneficial for the treatment of cardiac arrhythmia, ischemia, cardiomyopathy, valve diseases, etc. The time-varying motion of an anatomical structure such as the heart can be estimated using deep learning techniques, for example, by analyzing the visual features of multiple images of the structure recorded at different points in time (e.g., as in a video) and tracking the changes occurring between the images. Machine learning-based methods for such motion estimation have been implemented, but the accuracy of these methods still needs improvement.

### SUMMARY

Described herein are machine learning-based systems, methods and instrumentalities associated with motion estimation based on multiple image pairs. According to embodiments of the present disclosure, an apparatus may be configured to obtain a medical video associated with an anatomical structure and arrange a plurality of medical scan images of the medical video into multiple image pairs, wherein each image pair may include a first medical scan image that is associated with a first temporal position of the medical video and a second medical scan image that may be associated with a second temporal position of the medical video. The apparatus may then process the multiple image pairs via a machine learning (ML) model, wherein the multiple image pairs may be provided to the ML model successively based on the first temporal position or the second temporal position associated with each image pair. The ML model may be configured to determine respective first sets of image features associated with the multiple image pairs, refine the first set of image features associated with each image pair based on the respective first sets of image features associated with one or more other image pairs, and determine a motion field associated with each image pair based at least on the refined first set of image features associated with the image pair. The apparatus may then perform a medical task associated with the anatomical structure based on the respective motion fields associated with the multiple image pairs.

In some embodiments, the motion field associated with each image pair may indicate a motion of the anatomical structure between the first medical scan image of the image pair and the second medical scan image of the image pair.

In some embodiments, the anatomical structure may include a myocardium, the medical video may depict the myocardium within a cardiac cycle, and the medical task may include a determination of one or more strain values associated with the myocardium.

In some embodiments, the ML model may include an encoding portion and a decoding portion, wherein the first set of image features associated with each image pair may be determined via the encoding portion and refined via the decoding portion. The encoding portion of the ML model may be implemented via a twin neural network and the ML model being configured to determine the respective first sets of image features associated with the multiple image pairs may include the ML model being configured to extract respective image features from the first medical scan image and the second medical scan image of each image pair using the twin neural network, and concatenate the image features extracted from the first medical scan image and the second medical scan image to derive the first set of image features associated with the image pair.

In some embodiments, the decoding portion of the ML model may be implemented via a transformer neural network, wherein the ML model may be configured to refine the first set of image features associated with each image pair using a self-attention module of the transformer neural network.

In some embodiments, the decoding portion of the ML model may be implemented via a recurrent neural network (e.g., including a gated recurrent unit (GRU)), wherein the ML model may be configured to refine the first set of image features associated with each image pair based on one or more hidden states of the recurrent neural network.

In some embodiments, the first set of image features associated with each image pair may be characterized by a first spatial scale and the ML model may be further configured to determine respective second sets of image features associated with the multiple image pairs, wherein the second sets of image features may be characterized by a second spatial scale. The ML model may also be configured to refine the second set of image features associated with each image pair based on the respective second sets of image features associated with one or more other image pairs, and determine the motion field associated with the image pair further on the refined second set of image features associated with the image pair.

In some embodiments, the plurality of medical scan images of the medical video may be associated with a physiological cycle and the apparatus may be configured to arrange the plurality of medical scan images into the multiple image pairs by selecting, from the plurality of medical scan images, the same medical scan image (e.g., the medical scan image associated with a beginning of the physiological cycle) as the first medical scan image of each image pair, and selecting, from the plurality of medical scan images, a sequentially ordered set of medical scan images as the respective second medical scan images of the multiple image pairs.

In some embodiments, the apparatus may be configured to arrange the plurality of medical scan images into the multiple image pairs by selecting, from the plurality of medical scan images, a first set of sequentially ordered medical scan images as the respective first medical scan images of the multiple image pairs and selecting, from the plurality of medical scan images, a second set of sequentially ordered medical scan images as the respective second medical scan images of the multiple image pairs. The beginning image of the first set of sequentially ordered medical scan images may be positioned before the beginning image of the second set of sequentially ordered medical scan images in the medical video.

### BRIEF DESCRIPTION OF THE DRAWINGS

A more detailed understanding of the examples disclosed herein may be obtained from the following description, given by way of example in conjunction with the accompanying drawing.

FIG. 1 shows a simplified block diagram of an example apparatus that may be used to perform the operations for motion estimation based on a refined set of image features associated with multiple image pairs according to some embodiments described herein.

FIG. 2 shows a simplified diagram illustrating how a neural network may implement a machine learning (ML) model to perform the operations for motion estimation based on a refined set of image features associated with multiple image pairs as described herein.

FIG. 3 shows a flow diagram of an example method illustrating how the ML model may be trained to perform the operations for motion estimation based on a refined set of image features associated with multiple image pairs according to some embodiments described herein.

FIG. 4 shows a flow diagram illustrating an example method that may be performed for motion estimation based on a refined set of image features associated with multiple image pairs according to some embodiments described herein.

FIG. 5 shows a flow diagram illustrating an example method for determining respective second sets of image features from the multiple image pairs as described herein.

FIG. 6 shows a flow diagram illustrating an example method for arranging the plurality of medical scan images into the multiple image pairs as described herein.

FIG. 7 shows a flow diagram illustrating an example method for arranging the plurality of medical scan images into the multiple image pairs as described herein.

FIG. 8 is a block diagram illustrating an apparatus in the example form of a computer system, within which a set or sequence of instructions may be executed to cause the machine to perform any one of the methodologies discussed herein.

### DETAILED DESCRIPTION

As an initial matter, it is noted that various techniques may be used to estimate the motion of an anatomical structure between two images (e.g., magnetic resonance (MR) images). In some cases, a motion estimation system may first segment the images to identify the anatomical structure (e.g., a myocardium) in the images and then apply feature tracking to the segmentation results (e.g., binary segmentation masks) to determine the differences between the two images. In other cases, an image content-based motion estimation system may determine the motion of the anatomical structure directly from the images using deep learning-based models and methods.

A medical video obtained during a physiological cycle of the human body (e.g., such as a cardiac cycle) may provide temporal information (e.g., along the time axis in a sequence of images from the medical video) that may be used to improve the accuracy of motion tracking. With such temporal knowledge, the motion field generated for each time point of the physiological cycle may now be refined based on more image frames (e.g., because of the relationship of adjacent image frames during the physiological cycle). The implicit connection between the successively determined motion fields may provide an alternative to only considering two successive image frames (e.g., successive MR images) and, therefore, help make the successively determined motion fields conform to a known motion pattern (e.g., cardiac motion pattern). One or more examples are provided herein to illustrate the configuration, training, and operation of such a temporal refinement based approach. The examples are described in the context of cardiac motion estimation, but those skilled in the art will appreciate that the disclosed systems, methods and instrumentalities may also be used to estimate the motion of other anatomical structures and/or in other application areas.

The present disclosure is illustrated by way of example, and not by way of limitation, in the figures of the accompanying drawings.

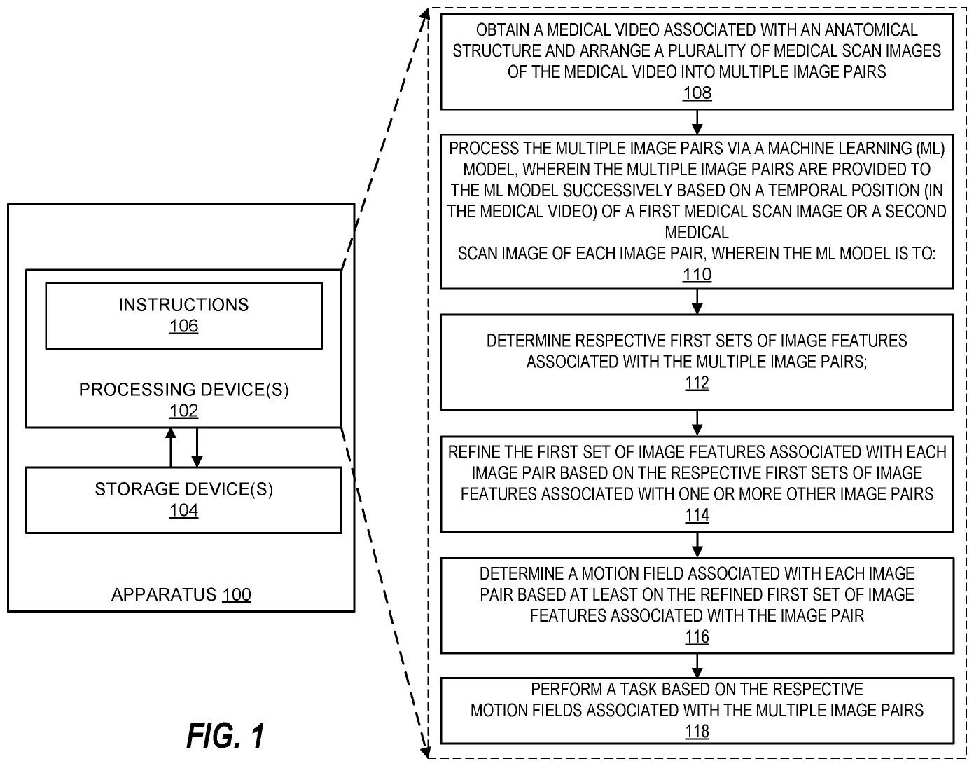

FIG. 1 shows a simplified block diagram of an example apparatus 100 that may be used to perform the operations for motion estimation based on multiple image pairs according to some embodiments described herein.

Apparatus 100 may be a standalone computer system or a networked computing resource implemented in a computing cloud, and may include processing device(s) 102 and storage device(s) 104, where the storage device 104 may be communicatively coupled to processing device 102. Processing device(s) 102 may include one or more processors such as a central processing unit (CPU), a graphic processing unit (GPU), or an accelerator circuit. The storage device(s) 104 may include a memory device, a hard disc, and/or a cloud storage device connected to processing device 102 through a network interface card (not shown in FIG. 1). Processing device(s) 102 may be programmed to use previously obtained data regarding the position and/or shape of an anatomical structure to predict the position and/or shape of the anatomical structure over a time period, so as to track the motion of the anatomical structure, via instructions 106.

The processing device(s) 102 may execute instructions 106 and perform the following operations for motion estimation based on refined sets of image features associated with multiple image pairs. At operation 108, obtain a medical video associated with an anatomical structure and arrange a plurality of medical scan images I of the medical video into multiple image pairs (I, I). For example, in order to exploit the temporal dimension, the input to apparatus 100 may be a sequence of MR images I from a video of the cardiac cycle of a myocardium. Multiple image pairs (I, I) combinations may be generated and arranged from the input sequence of images. The arrangement of the image pairs may be based on the temporal position of the first image of each pair (e.g., along the time axis of the medical video of the cardiac cycle) or the temporal position of the second image of each pair, as explained more fully below with respect to operation 110.

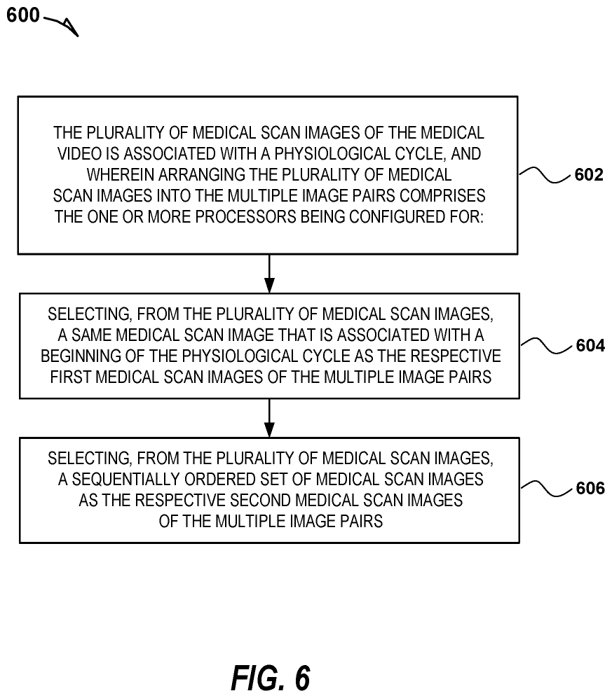

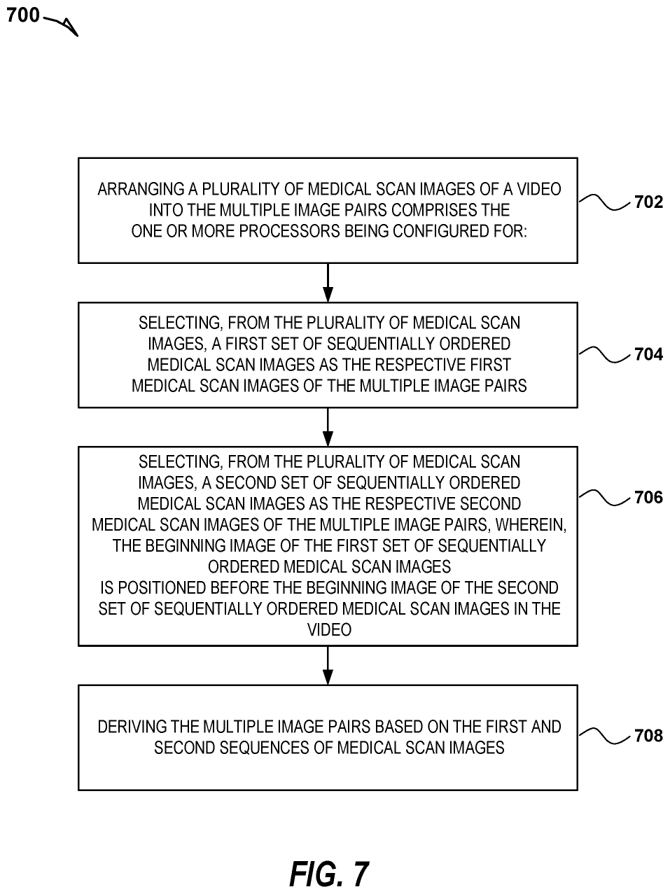

At operation 110, the apparatus may process the multiple image pairs via a machine learning (ML) model, wherein the multiple image pairs (I, I) may be provided to the ML model successively based on the temporal position (e.g., along the time axis of the medical video of the cardiac cycle) of the first medical scan image or the temporal position of the second medical scan image of each image pair. For example, according to one embodiment (e.g., as illustrated in FIG. 6), for each image pair, the first image may be the same end-diastolic (ED) image (I_{T}) and the second image may be the next image along the time axis of the video of the cardiac cycle (e.g., I_{T+1}, I_{T+2}, I_{T+3}). Then, the image pairs may be arranged according to the position of the second image of each pair along the time axis of the video (e.g., sequentially): (I_{T}, I_{T+1}), (I_{T}, I_{T+2}), (I_{T}, I_{T+3}), etc. In another embodiment (see FIG. 7), each image pair may be spread equally (and sequentially) across the time axis of the medical video of the cardiac cycle. For example, the first sequence of images may be I_{T}, I_{T+1}, I_{T+2}, etc. and the second sequence of images may be I_{T+1}, I_{T+2}, I_{T+3}, etc. The beginning image of the first sequence of images (e.g., I_{T}) may be positioned before the beginning image of the second sequence of images (e.g., I_{T+1}). The image pairs may be arranged (e.g., provided to the ML model) according to the position of the first image of each pair along the time axis of the video: (I_{T}, I_{T+1}), (I_{T+1}, I_{T+2}), (I_{T+2}, I_{T+3}), etc.

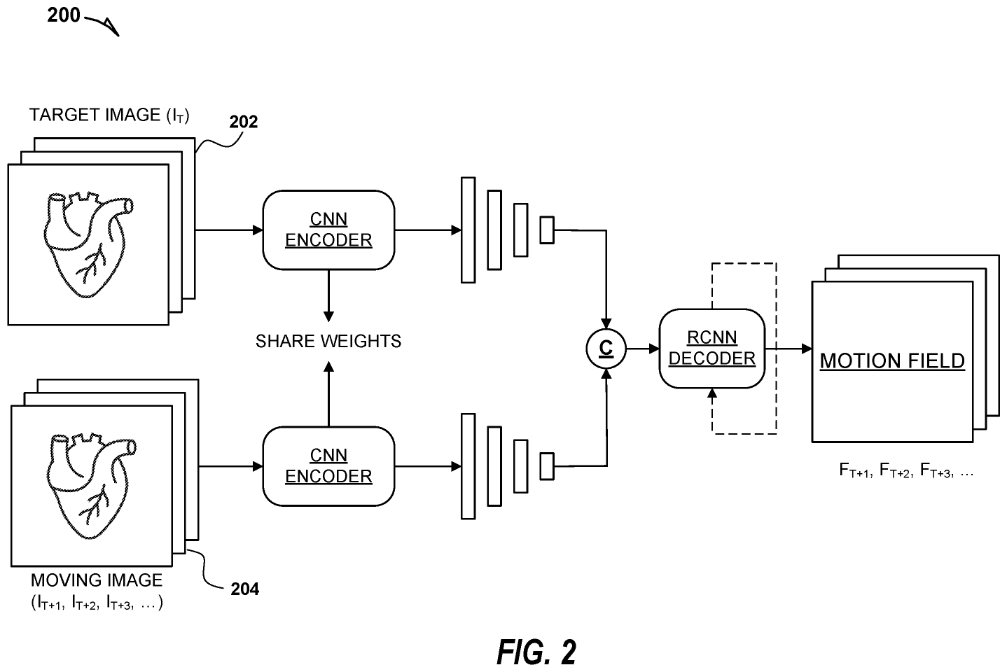

At operation 112, the ML model may be configured to determine respective first sets of image features associated with the multiple image pairs. Convolutional neural networks (CNNs) (e.g., twin convolutional neural network) may be used to implement the ML model for determining the features associated with the image pairs. At operation 114, the ML model may be configured to, for each of the multiple image pairs, refine the first set of image features associated with the image pair based on the respective first sets of image features associated with one or more other image pairs (e.g., previously processed image pairs). For example, the features extracted from a pair of images may be used by the ML model to refine the features extracted from the next pair of images. As explained more fully with respect to FIG. 2 below, the input image pairs may be encoded (e.g., by a CNN-based or transformer-based encoder) and provided to a decoder (e.g., a CNN-based or transformer-based decoder), where the extracted features from temporally successive pairs of images may be fused to exchange information. In this way, the extracted features for one pair of images may have a larger receptive field (e.g., used together with other pairs of images) along the time axis of the medical video (e.g., of the cardiac cycle of the myocardium).

At operation 116, the ML model may be configured to determine a motion field F associated with each image pair based at least on the refined first set of image features associated with the image pair. The motion field F associated with each image pair may indicate a motion of the anatomical structure (e.g., myocardium) between the first medical scan image of the image pair and the second medical scan image of the image pair. The refined image features may combine both local and global information extracted from the medical video. Furthermore, the generated motion fields F_{T+1}, F_{T+2}, F_{T+3}, . . . for successive image pairs processed by the ML model may be fused to utilize multi-scale features along the temporal dimension. There may be different ways to fuse the motion fields. One example way may involve using another neural network (e.g., a CNN, a transformer, etc.) to take F_{T+1}, F_{T+2}, F_{T+3} . . . as input and output new motion fields. Another example way may involve using a neural network such as a recurrent neural network (RNN) to estimate one motion field (e.g., F_{T+2}) based on the hidden state saved from the estimation of another motion field (e.g., F_{T+1}), so that F_{T+2} may be estimated using information associated with F_{T+1}. As will be explained more fully with respect to FIG. 2 below, the unit deployed to fuse temporal information may be implemented by recurrent or transformer units.

At operation 118, the apparatus may then perform a medical task associated with the anatomical structure based on the respective motion fields associated with the multiple image pairs. For example, the motion fields may be used for determining one or more strain values associated with a myocardium based on the medical video being a video of the cardiac cycle of the myocardium.

FIG. 2 shows a simplified diagram illustrating how a neural network 200 may implement a machine learning (ML) model to perform the operations for motion estimation based on multiple image pairs as described herein.

The ML model may include an encoding portion (e.g., a CNN-based or transformer-based encoder) and a decoding portion (e.g., an RCNN decoder or a transformer-based decoder). The encoding portion may be configured to determine image features associated with each image pair (e.g., target image 202 and moving images 204) and the decoding portion may be configured to decode (or transform) the encoded image features into a motion field (e.g., which may indicate changes or movements of an object between the pair of images). The encoding portion of the ML model may be implemented via a twin neural network (e.g., using a Siamese network structure). The neural network 200 may take successive image pairs (I_{T}, I_{T+1}), (I_{T}, I_{T+2}), (I_{T}, I_{T+3}) . . . as input and features extracted from an image pair may be provided to the next image pair processed by the neural network 200. The input image pairs may be encoded by the twin neural network that share parameters/weights inside the Siamese network structure. Respective image features from the first image and the second image of each image pair may be extracted using the twin neural network 200 and then concatenated (C) to derive the first set of image features associated with the image pair.

The neural network 200 may learn or capture the temporal interaction between successive image pairs and/or motion fields (e.g., F_{T+1}, F_{T+2}, F_{T+3} . . . ) in two stages. The first stage may be performed by the RNN decoder, wherein the extracted features from temporally successive image pairs may be refined to exchange information with each other so that the extracted feature for one pair of images can have a larger receptive field along the time axis (e.g., of the medical video). The refined features may then be used (e.g., by the RNN decoder) to determine the motion fields F_{T+1}, F_{T+2}, F_{T+3} . . . The second stage may be a refining stage or adjustment stage for the motion fields determined during the first stage (e.g., by making adjustment/corrections to the motion fields generated at the first stage). This may be accomplished, for example, using another neural network that may be configured to take the motion fields from the first stage as inputs and output the same number of motion fields with improved accuracy (e.g., by estimating and applying corrections/adjustments to the input motion fields).

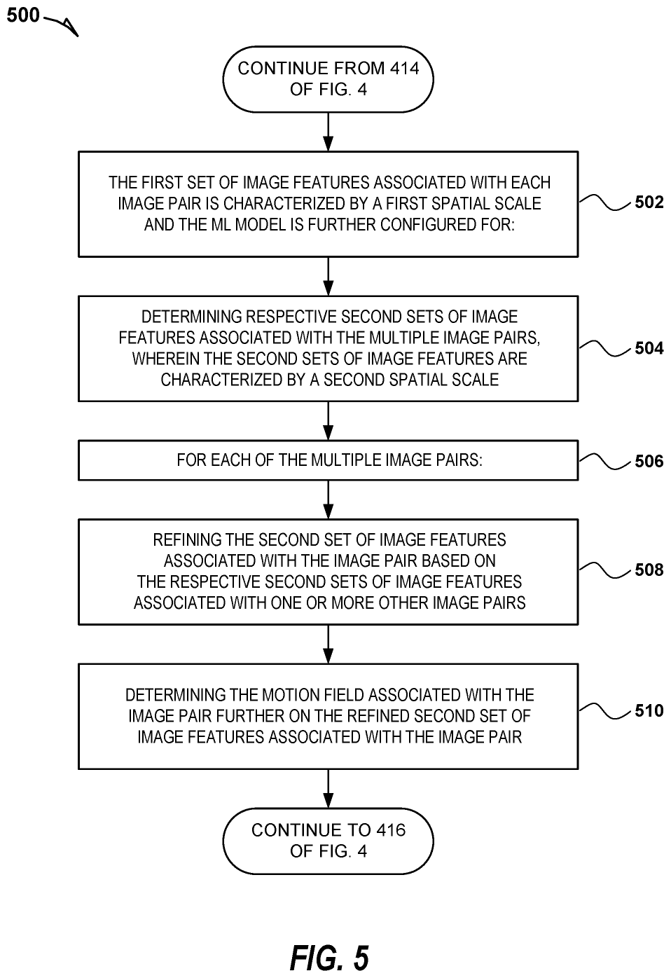

As noted above, the decoding portion of the ML model may be implemented via a recurrent neural network (RNN) such as a recurrent convolutional neural network (RCNN) configured to refine the first set of image features associated with each image pair based on one or more hidden states of the recurrent neural network. The RNN may include one or more gated recurrent units (GRUs) as the recurrent units and the linear layers of the GRUs may be replaced with convolution layers to process the 2D features extracted from each image pair at each time step T, T+1, T+2, . . . Compared to a regular RNN building block (e.g., a recurrent unit), a GRU may include an additional gating mechanism that may be configured to control whether to use or discard a hidden state. For the temporal fusion, in the first stage, the RNN decoder may receive feature maps with different spatial resolutions. Then the extracted features from consecutive image pairs may exchange information for each scale (see FIG. 5). The neural network 200 may learn the global temporal motion and refine the features for each image pair based on the temporal motion information. The feature maps with different spatial scales may be up-sampled to the same resolution and concatenated to generate the motion field. In the second stage, the RNN may fuse consecutive motion along the time scale to get the final motion fields.

As noted above, the decoding portion of the ML model may be implemented via a transformer configured to refine the first set of image features associated with each image pair using a self-attention module of the transformer neural network. The features extracted from image pairs from successive time steps may be provided to the transformer neural network, which may apply the attention mechanism on the time axis to fuse the temporal information. Additional convolutional layers between attention blocks may be used to encode the features in the spatial dimension.

The neural networks described herein (e.g., the motion estimation neural network system 200) may be implemented using one or more processors, one or more storage devices, and/or other suitable accessory devices such as display devices, communication devices, input/output devices, etc. The storage devices may be configured to store instructions that, when executed by the one or more processors, cause the one or more processors to perform the functions described herein. The one or more processors may include a central processing unit (CPU), a graphics processing unit (GPU), a microcontroller, a reduced instruction set computer (RISC) processor, an application specific integrated circuit (ASIC), an application-specific instruction-set processor (ASIP), a physics processing unit (PPU), a digital signal processor (DSP), a field programmable gate array (FPGA), or a combination thereof. The one or more storage devices may include volatile or non-volatile memory such as semiconductor memory (e.g., electrically programmable read-only memory (EPROM), electrically erasable programmable read-only memory (EEPROM), etc.), flash memory, a mass storage device (e.g., a magnetic disk such as an internal hard disk, a removable disk, a magneto-optical disk, a CD-ROM or DVD-ROM disk, etc.).

In addition, although the examples are described herein with reference to various types of neural networks, various types of layers, and/or various tasks being performed by certain types of neural networks or layers, the references are made merely for illustration purposes and not meant to limit the scope of the disclosure.

Each of the neural networks described herein may comprise multiple layers including an input layer, one or more convolutional layers, one or more non-linear activation layers, one or more pooling layers, one or more fully connected layers, and/or an output layer. Each of the layers may correspond to a plurality of filters (e.g., kernels) and each filter may be designed to detect (e.g., learn) a set of key-points that collectively represent a respective feature or pattern. The filters may be associated with respective weights that, when applied to an input, produce an output indicating whether certain visual features or patterns have been detected. The weights associated with the filters may be learned by the neural networks through a training process that comprises inputting a large number of images from one or more training datasets to the neural networks, calculating differences or losses resulting from the weights currently assigned to the filters (e.g., based on an objective function such as mean squared error or L1 norm, a margin based loss function, etc.), and updating the weights assigned to the filters so as to minimize the differences or losses (e.g., based on stochastic gradient descent).

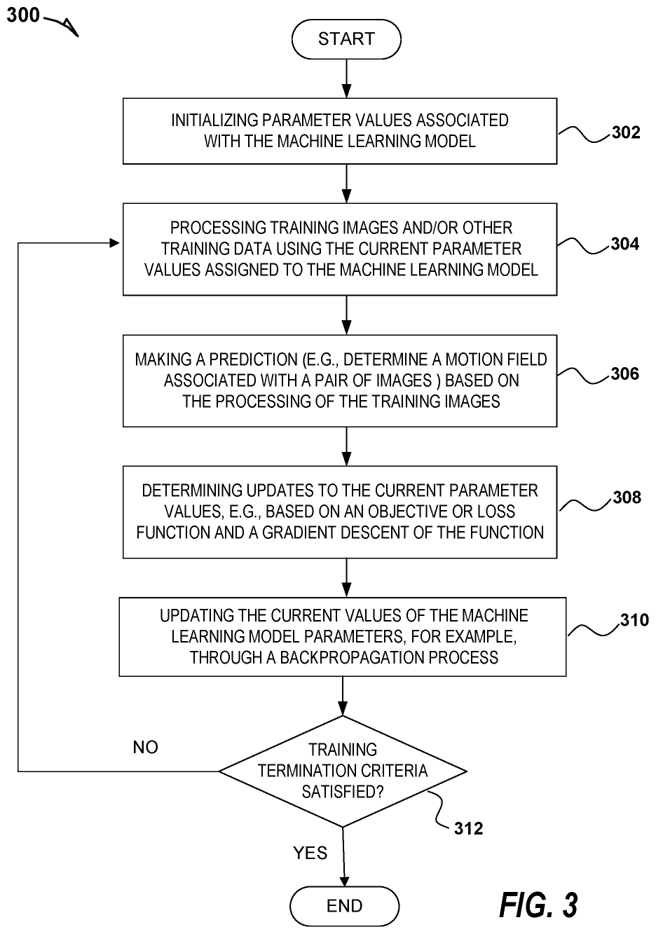

FIG. 3 shows a flow diagram of an example method 300 illustrating how the ML model (e.g., implemented and/or learned using an artificial neural network) may be trained to perform the operations for motion estimation based on a refined set of image features associated with multiple image pairs according to some embodiments described herein.

The training process (e.g., method 300) may be performed by a system of one or more computers. At operation 302, the system may initialize the operating parameters of the machine learning model (e.g., weights associated with various layers of the artificial neural network used to implement the machine learning model). For example, the system may initialize the parameters based on samples from one or more probability distributions or parameter values associated with a similar machine learning model.

At operation 304, the system may process training images and/or other training data, such as medical scan images from a medical video of the cardiac cycle of a myocardium, using the current parameter values assigned to the machine learning model.

At operation 306, the system may make a prediction (e.g., determine a motion field associated with a pair of the medical scan images) based on the processing of the training images.

At operation 308, the system may determine updates to the current parameter values associated with the machine learning model, e.g., based on an objective or loss function and a gradient descent of the function. As described herein, the objective or loss function may be designed to measure a difference between the prediction and a ground truth. The objective function may be implemented using, for example, mean squared errors, L1 norm, etc. associated with the prediction and/or the ground truth.

For example, each image pair (e.g., target image and moving image) may be compared and the difference between the moving image and the target image can be measured using mean square error, negative cross correlation, etc. These measurements may be used as loss function to be back-propagated to update the ML model parameters. Beyond the image pair, any two images from the medical video sequence may also be compared by exploiting the composition of motion fields. For example, for images I_{T} and I_{T+4}, a composite motion field from time T to time T+4 may be composed according to: F(T, T+1)+F(T+1, T+2)+F(T+2, T+3)+F(T+3, T+4).

At operation 310, the system may update the current values of the machine learning model parameters, for example, by backpropagating the gradient descent of the loss function through the artificial neural network. The learning process may be an iterative process, and may include a forward propagation process to predict an output (e.g., prediction) based on the machine learning model and the input data fed into the machine learning model, and a backpropagation process to adjust parameters of the machine learning model based on a gradience descent associated with a calculated difference between the desired output (e.g., ground truth) and the predicted output.

At operation 312, the system may determine whether one or more training termination criteria are satisfied. For example, the system may determine that the training termination criteria are satisfied if the system has completed a pre-determined number of training iterations, or if the change in the value of the loss function between two training iterations falls below a predetermined threshold. If the determination at 312 is that the training termination criteria are not satisfied, the system may return to 304. If the determination at 312 is that the training termination criteria are satisfied, the system may end the training process 300.

After training, the system (e.g., a replica of the system) may receive new data inputs (e.g., a medical video of an anatomical structure) associated with a motion tracking task and determine, based on the trained machine learning model, an estimated output in the form of a predicted outcome for the tasks (e.g., motion estimation based on a image pairs derived from the medical video).

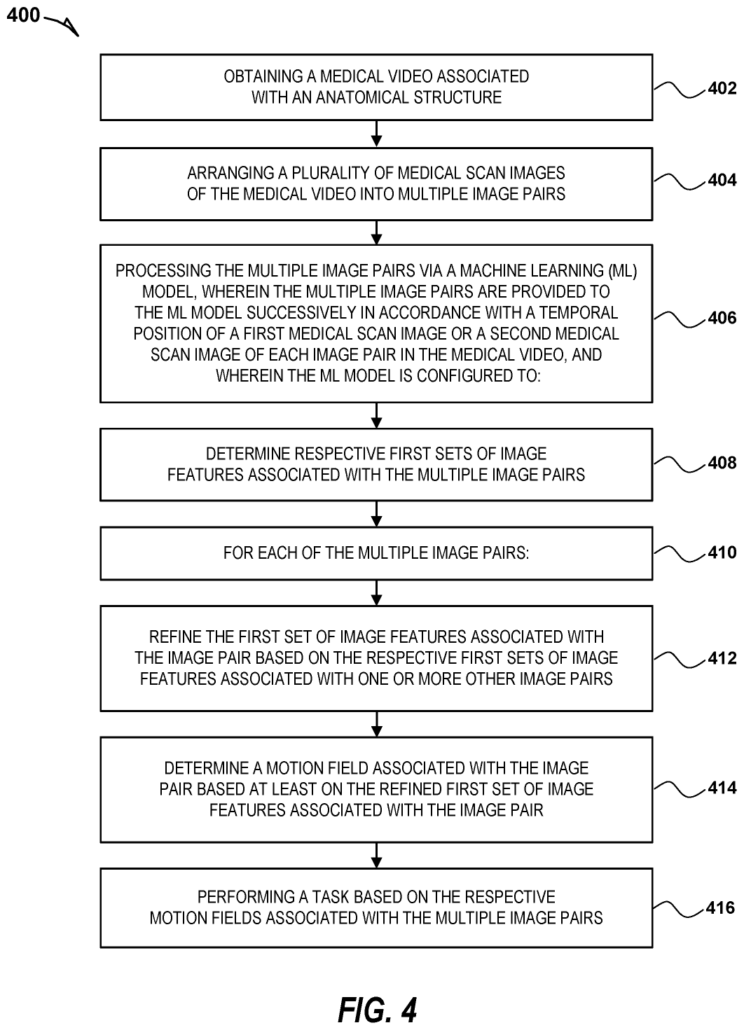

FIG. 4 shows a flow diagram illustrating an example method 400 that may be performed for motion estimation based on multiple image pairs according to some embodiments described herein.

The method 400 may start and then continue to operation 402 obtaining a medical video associated with an anatomical structure. As noted above, in order to exploit the temporal dimension, medical video may include a sequence of MR images I from a video of the cardiac cycle of a myocardium. Multiple image pairs (I, I) may be generated and arranged from the input sequence of images.

At operation 404, arranging a plurality of medical scan images I of the medical video into multiple image pairs (I, I). As noted above, the arrangement of the image pairs may be based on the temporal position of the first image of the pair (e.g., along the time axis of the medical video of the cardiac cycle) or the temporal position of the second image of the pair, as explained more fully below with respect to operation 406.

At operation 406, processing the multiple image pairs via a machine learning (ML) model, wherein the multiple image pairs (I, I) are provided to the ML model successively in accordance with a temporal position (e.g., along the time axis of the medical video of the cardiac cycle) of a first medical scan image (see FIG. 7) or a second medical scan image (see FIG. 6) of each image pair in the medical video.

At operation 408, determining respective first sets of image features associated with the multiple image pairs. As noted above, CNNs may be used for determining features associated the image pairs because CNNs may be specifically designed (see FIG. 2) for processing images and performing image analysis tasks (e.g., image classification, object detection, image segmentation etc.) for extracting complex and descriptive features from the image pairs.

At operations 410+412, for each of the multiple image pairs, refining the first set of image features associated with the image pair based on the respective first sets of image features associated with one or more other image pairs. As noted above, the features extracted from a pair of images may be provided to the next pair of images processed by the ML model.

At operation 410+414, for each of the multiple image pairs, determining a motion field F associated with the image pair based at least on the refined first set of image features associated with the image pair. As noted above, the motion field F associated with each image pair may indicate a motion of the anatomical structure (e.g., myocardium) between the first medical scan image of the image pair and the second medical scan image of the image pair. The motion field F associated with the image pair may be generated by combining local and global extracted features.

At operation 416, performing a medical task based on the respective motion fields associated with the multiple image pairs. As noted above, the motion fields may be used for determining one or more strain values associated with a myocardium based on the medical video being a video of the cardiac cycle of the myocardium. The method 400 may then end.

FIG. 5 shows a flow diagram illustrating an example method 500 for determining respective second sets of image features from the multiple image pairs as described herein.

The method 500 may continue from operation 414 of method 400 of FIG. 4 and then continue to operation 502 characterizing the first set of image features associated with each image pair by a first spatial scale (e.g., a first resolution). For example, the dimensions and/or pixel count of the images from the medical video of the anatomical structure for determining the spatial scale.

At operation 504, determining respective second sets of image features associated with the multiple image pairs, wherein the second sets of image features are characterized by a second spatial scale (e.g., a second resolution).

At operation 506+508, for each of the multiple image pairs, refining the second set of image features associated with the image pair based on the respective second sets of image features associated with one or more other image pairs. As noted above, the features extracted from a pair of images may be provided to the next pair of images processed by the ML model.

At operation 506+510, for each of the multiple image pairs, determining the motion field F associated with the image pair further on the refined second set of image features associated with the image pair. As noted above, the motion field F associated with each image pair may indicate a motion of the anatomical structure (e.g., myocardium) between the first medical scan image of the image pair and the second medical scan image of the image pair. The motion field F associated with the image pair may be generated by combining local and global extracted features. The method 500 may then continue to operation 416 of method 400 of FIG. 4.

FIG. 6 shows a flow diagram illustrating an example method 600 for arranging the plurality of medical scan images into the multiple image pairs as described herein.

The method 600 may start and then continue to operation 602 where the plurality of medical scan images of the medical video may be associated with a physiological cycle and the one or more processors may be configured for arranging the plurality of medical scan images into the multiple image pairs.

At operation 604, selecting, from the plurality of medical scan images, the same medical scan image as the first medical scan images of each of the multiple image pairs. As noted above, the selected first image may be associated with a beginning of the physiological cycle, such as, e.g., the same end-diastolic (ED) image (I_{T}).

At operation 606, selecting, from the plurality of medical scan images, a sequentially ordered set of medical scan images as the respective second medical scan images of the multiple image pairs. As noted above, the selected second image may be the next image along the time axis of the video of the cardiac cycle (e.g., I_{T+1}, I_{T+2}, I_{T+3}). Then, the image pairs may be arranged according to the position of the second image of each pair along the time axis of the video: (I_{T}, I_{T+1}), (I_{T}, I_{T+2}), (I_{T}, I_{T+3}), etc.

FIG. 7 shows a flow diagram illustrating an example method 700 for arranging the plurality of medical scan images (e.g., from a medical video) into the multiple image pairs as described herein.

The method 700 may start and then continue to operation 702 the one or more processors may be configured for arranging the plurality of medical scan images into the multiple image pairs.

At operation 706, selecting, from the plurality of medical scan images, a first set of sequentially ordered medical scan images as the respective first medical scan images of the multiple image pairs. As noted above, the selected first sequence of images may be I_{T}, I_{T+1}, I_{T+2}, etc.

At operation 706, selecting, from the plurality of medical scan images, a second set of sequentially ordered medical scan images as the respective second medical scan images of the multiple image pairs. As noted above, the second sequence of images may be I_{T+1}, I_{T+2}, I_{T+3}, etc. (e.g., the beginning image of the first set of sequentially ordered medical scan images may be positioned before the beginning image of the second set of sequentially ordered medical scan images in the medical video).

At operation 708, deriving the multiple image pairs based on the first and second sequences of medical scan images. As noted above, each image pair may be spread equally across the time axis of the medical video of the cardiac cycle. For example, the image pairs may be arranged according to the position of the first image of each pair along the time axis of the video: (I_{T}, I_{T+1}), (I_{T+1}, I_{T+2}), (I_{T+2}, I_{T+3}), etc.

For simplicity of explanation, the operations of the methods (e.g., performed by apparatus 100 of FIG. 1) are depicted and described herein with a specific order. It should be appreciated, however, that these operations may occur in various orders, concurrently, and/or with other operations not presented or described herein. Furthermore, it should be noted that not all operations that the apparatus is capable of performing are depicted in FIGS. 3-7 or described herein. It should also be noted that not all illustrated operations may be required to be performed.

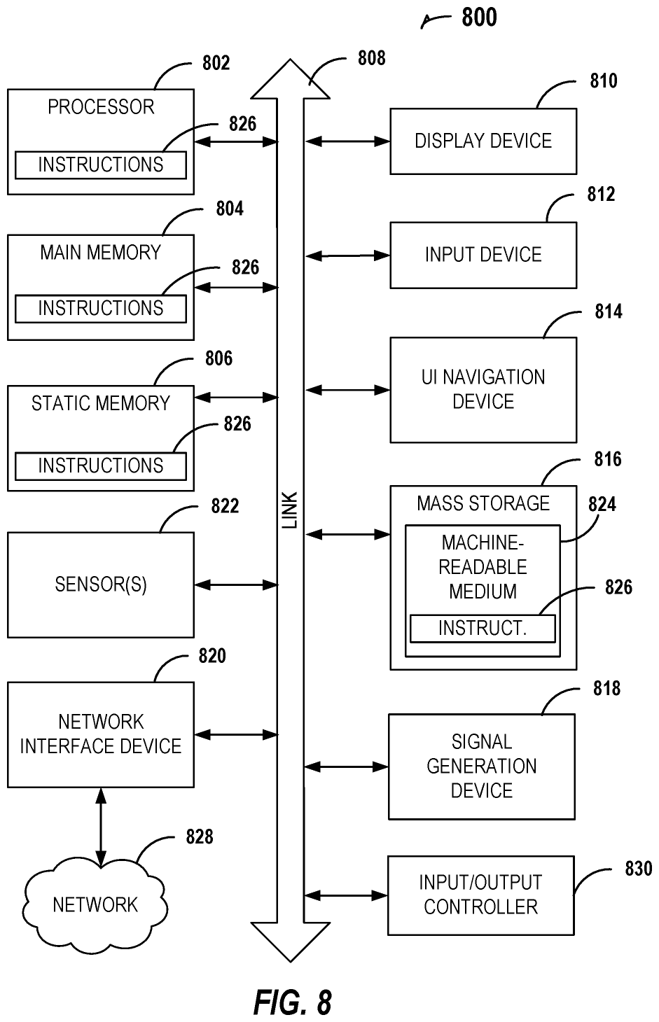

FIG. 8 is a block diagram illustrating an apparatus in the example form of a computer system 800, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein (e.g., method 300 of FIG. 3, method 400 of FIG. 4, method 500 of FIG. 5, method 600 of FIG. 6 and method 700 of FIG. 7).

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors 822, such as a global positioning system (GPS) sensor, accelerometer, gyrometer, magnetometer, or other such sensor.

The storage device 816 includes a machine-readable medium 824 on which is stored one or more sets of data structures and instructions 826 (e.g., software) embodying or utilized by any one or more of the methodologies or functions described herein. The instructions 826 may also reside, completely or at least partially, within the main memory 804, static memory 806, and/or within the processor 802 during execution thereof by the computer system 800, with main memory 804, static memory 806, and the processor 802 comprising machine-readable media.

While the machine-readable medium 824 is illustrated in an example embodiment to be a single medium, the term “machine-readable medium” may include a single medium or multiple media (e.g., a centralized or distributed database, and/or associated caches and servers) that store the one or more instructions 826. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 826 may further be transmitted or received over a communications network 828 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 16G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 800 may also include an input/output controller 830 to receive input and output requests from at least one central processor 802, and then send device-specific control signals to the device they control. The input/output controller 830 may free at least one central processor 802 from having to deal with the details of controlling each separate kind of device.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus, comprising:
one or more processors configured to:
obtain a medical video associated with an anatomical structure;
arrange a plurality of medical scan images of the medical video into multiple image pairs, wherein each image pair includes a first medical scan image that is associated with a first temporal position of the medical video and a second medical scan image that is associated with a second temporal position of the medical video;
process the multiple image pairs via a machine learning (ML) model, wherein the multiple image pairs are provided to the ML model successively based on the first temporal position or the second temporal position associated with each image pair, and wherein the ML model is configured to:
determine respective first sets of image features associated with the multiple image pairs;
refine the first set of image features associated with each image pair based on the respective first sets of image features associated with one or more other image pairs; and
determine a motion field associated with each image pair based at least on the refined first set of image features associated with the image pair; and
perform a medical task associated with the anatomical structure based on the respective motion fields associated with the multiple image pairs.

2. The apparatus of claim 1, wherein the motion field associated with each image pair indicates a motion of the anatomical structure between the first medical scan image of the image pair and the second medical scan image of the image pair.

3. The apparatus of claim 1, wherein the anatomical structure includes a myocardium, the medical video depicts the myocardium within a cardiac cycle, and the medical task includes a determination of one or more strain values associated with the myocardium.

4. The apparatus of claim 1, wherein the ML model includes an encoding portion and a decoding portion, and wherein the first set of image features associated with each image pair is determined via the encoding portion and refined via the decoding portion.

5. The apparatus of claim 4, wherein the encoding portion of the ML model is implemented via a twin neural network, and wherein the ML model being configured to determine the respective first sets of image features associated with the multiple image pairs comprises the ML model being configured to:
extract respective image features from the first medical scan image and the second medical scan image of each image pair using the twin neural network; and
concatenate the image features extracted from the first medical scan image and the second medical scan image to derive the first set of image features associated with the image pair.

6. The apparatus of claim 4, wherein the decoding portion of the ML model is implemented via a transformer neural network and wherein the ML model is configured to refine the first set of image features associated with each image pair using a self-attention module of the transformer neural network.

7. The apparatus of claim 4, wherein the decoding portion of the ML model is implemented via a recurrent neural network comprising a gate recurrent unit, and wherein the ML model is configured to refine the first set of image features associated with each image pair based on one or more hidden states of the recurrent neural network.

8. The apparatus of claim 1, wherein the first set of image features associated with each image pair is characterized by a first spatial scale, and wherein the ML model is further configured to:
determine respective second sets of image features associated with the multiple image pairs, wherein the second sets of image features are characterized by a second spatial scale;
refine the second set of image features associated with each image pair based on the respective second sets of image features associated with one or more other image pairs; and
determine the motion field associated with the image pair further on the refined second set of image features associated with the image pair.

9. The apparatus of claim 1, wherein the plurality of medical scan images of the medical video is associated with a physiological cycle, and wherein the one or more processors being configured to arrange the plurality of medical scan images into the multiple image pairs comprises the one or more processors being configured to:
select, from the plurality of medical scan images, a same medical scan image as the first medical scan image of each image pair, wherein the selected medical scan image is associated with a beginning of the physiological cycle; and
select, from the plurality of medical scan images, a sequentially ordered set of medical scan images as the respective second medical scan images of the multiple image pairs.

10. The apparatus of claim 1, wherein the one or more processors being configured to arrange the plurality of medical scan images into the multiple image pairs comprises the one or more processors being configured to:
select, from the plurality of medical scan images, a first set of sequentially ordered medical scan images as the respective first medical scan images of the multiple image pairs; and
select, from the plurality of medical scan images, a second set of sequentially ordered medical scan images as the respective second medical scan images of the multiple image pairs;
wherein a beginning image of the first set of sequentially ordered medical scan images is positioned before a beginning image of the second set of sequentially ordered medical scan images in the medical video.

11. A method for estimating a motion of an anatomical structure, the method comprising:
obtaining a medical video associated with the anatomical structure;
arranging a plurality of medical scan images of the medical video into multiple image pairs, wherein each image pair includes a first medical scan image that is associated with a first temporal position of the medical video and a second medical scan image that is associated with a second temporal position of the medical video;
processing the multiple image pairs via a machine learning (ML) model, wherein the multiple image pairs are provided to the ML model successively based on the first temporal position or the second temporal position associated with each image pair, and wherein the ML model is configured to:
determine respective first sets of image features associated with the multiple image pairs;
refine the first set of image features associated with each image pair based on the respective first sets of image features associated with one or more other image pairs; and
determine a motion field associated with each image pair based at least on the refined first set of image features associated with the image pair; and
performing a medical task associated with the anatomical structure based on the respective motion fields associated with the multiple image pairs.

12. The method of claim 11, wherein the motion field associated with each image pair indicates the motion of the anatomical structure between the first medical scan image of the image pair and the second medical scan image of the image pair.

13. The method of claim 11, wherein the anatomical structure includes a myocardium, the medical video depicts the myocardium within a cardiac cycle, and the medical task includes determining one or more strain values associated with the myocardium.

14. The method of claim 11, wherein the ML model includes an encoding portion and a decoding portion, and wherein the first set of image features associated with each image pair is determined via the encoding portion and refined via the decoding portion.

15. The method of claim 14, wherein the encoding portion of the ML model is implemented via a twin neural network, and wherein the ML model being configured to determine the respective first sets of image features associated with the multiple image pairs comprises the ML model being configured to:
extract respective image features from the first medical scan image and the second medical scan image of each image pair using the twin neural network; and
concatenate the image features extracted from the first medical scan image and the second medical scan image to derive the first set of image features associated with the image pair.

16. The method of claim 15, wherein the decoding portion of the ML model is implemented via a transformer neural network and wherein the ML model is configured to refine the first set of image features associated with each image pair using a self-attention module of the transformer neural network.

17. The method of claim 15, wherein the decoding portion of the ML model is implemented via a recurrent neural network comprising a gated recurrent unit and wherein the ML model is configured to refine the first set of image features associated with each image pair based on one or more hidden states of the recurrent neural network.

18. The method of claim 11, wherein the first set of image features associated with each image pair is characterized by a first spatial scale, and wherein the ML model is further configured to:
determine respective second sets of image features associated with the multiple image pairs, wherein the second sets of image features are characterized by a second spatial scale; and
for each of the multiple image pairs:
refine the second set of image features associated with the image pair based on the respective second sets of image features associated with one or more other image pairs; and
determine the motion field associated with the image pair based further on the refined second set of image features associated with the image pair.

19. The method of claim 11, wherein the plurality of medical scan images of the medical video is associated with a physiological cycle, and wherein arranging the plurality of medical scan images into the multiple image pairs comprises:
selecting, from the plurality of medical scan images, a same medical scan image as the first medical scan image of each image pair, wherein the selected medical scan image is associated with a beginning of the physiological cycle; and
selecting, from the plurality of medical scan images, a sequentially ordered set of medical scan images as the respective second medical scan images of the multiple image pairs.

20. The method of claim 11, wherein arranging the plurality of medical scan images into the multiple image pairs comprises:
selecting, from the plurality of medical scan images, a first set of sequentially ordered medical scan images as the respective first medical scan images of the multiple image pairs; and
selecting, from the plurality of medical scan images, a second set of sequentially ordered medical scan images as the respective second medical scan images of the multiple image pairs;
wherein a beginning image of the first set of sequentially ordered medical scan images is positioned before a beginning image of the second set of sequentially ordered medical scan images in the medical video.
